(19) United States
(12) Patent Application Publication
(10) Pub. No.: US 2021/0157987 A1
(43) Pub. Date: May 27, 2021

(54) INFORMATION PROCESSING APPARATUS, INFORMATION PROCESSING METHOD, AND COMPUTER-READABLE RECORDING MEDIUM

(71) Applicant: NEC CORPORATION, Tokyo (JP)

(72) Inventors: Takuya KAWADA, Tokyo (JP); Kunihiko SADAMASA, Tokyo (JP)

(73) Assignee: NEC CORPORATION, Tokyo (JP)

(21) Appl. No.: 16/613,502

(22) PCT Filed: May 14, 2018
(86) PCT No.: PCT/JP2018/018613

§ 371 Date: Nov. 14, 2019

(30) Foreign Application Priority Data
May 17, 2017 (JP) 2017-098383

(51) Int. Cl. G06F 40/35; G06F 40/279; G08B 5/22

(52) U.S. Cl. CPC G06F 40/35; G06F 40/205; G08B 5/22; G06F 40/279

(57) ABSTRACT

An information processing apparatus (10) includes a speech act formula generation unit (12) and an adjacency pair extraction unit (14). Dialogue text described in natural language is input to the speech act formula generation unit (12). The adjacency pair extraction unit (14) extracts, using preset pair information, pairs of speech act formulas that indicate adjacency pairs, from a plurality of speech act formulas generated by the speech act formula generation unit (12). Specifically, the adjacency pair extraction unit (14) extracts, as a pair of speech act formulas indicating an adjacency pair, a speech act formula generated from an arbitrary utterance text passage in the dialog text and one of a plurality of speech act formulas generated from a plurality of other utterance text passages, the one speech act formula including a predicate that forms a predicate pair with a predicate included in the arbitrary speech act formula.

### TECHNICAL FIELD

The invention relates to an information processing apparatus for analyzing the meaning of dialog text, an information processing method therefore, and a computer-readable recording medium having recorded thereon a program therefor.

### BACKGROUND ART

Development of technology to analyze text that indicates speech acts of a plurality of people and extract useful information has progressed. Note that text that indicates a series of conversations formed of utterances made by a plurality of people is referred to as “dialog text”. Also, in the dialog text, text that indicates one utterance is referred to as an “utterance text passage”. Patent Document 1 discloses an apparatus for analyzing dialog text including the contents of a plurality of utterances, for example.

With the analysis apparatus disclosed in Patent Document 1, a first utterance and a second utterance that are a response pair (adjacency pair) in dialog text are specified, and whether or not the matter of the first utterance is denied in the second utterance is determined. Then, if the matter of the first utterance is denied in the second utterance, data resulting from removing the matter of the denied first utterance from the dialog text is generated as text processed data. The matter denied in a dialog is deleted from the text processing data generated in this manner, and thus text processing such as data mining can be performed accurately.

In order to process dialog text such as that described above using a computer, dialog text expressed by natural language need be converted into an expression described in a logical language form (formal language). In view of this, a semantic parser has conventionally been used to convert natural language into a formal language (see Non-Patent Document 1, for example). With the semantic parser, text expressed in natural language is converted into an expression in a formal language based on preset parameters.

### LIST OF RELATED ART DOCUMENTS

### Patent Document

Patent Document 1: Japanese Patent No. 5867410

### Non Patent Document

Non-Patent Document 1: Percy Liang, Michael Jordan, and Dan Klein. 2011. Learning dependency-based compositional semantics. In Proceedings of the Human Language Technology Conference of the Association for Computational Linguistics, pages 590-599, Portland, Oreg.

### SUMMARY OF INVENTION

### Problems to be Solved by the Invention

Incidentally, in dialog text, there may be a dependent relationship in a speech act, which is represented by adjacency pairs such as “request-agreement” and “question answer”, between utterance text passages that form the dialog text.

However, an object that can be analyzed by a conventional semantic parser is limited to one independent utterance text passage, and when the meaning of one utterance text passage is analyzed, it is not possible to refer to other utterance text passages in the dialog text. In other words, with a conventional semantic parser, semantic analysis is executed on each independent utterance text passage, and thus when one utterance text passage is subjected to semantic analysis, a dependent relationship with another utterance text passage cannot be considered.

Assume that dialog text between Companies A and B includes the utterance text “We will choose containership, too.” made by Company B, for example. In this case, it is conceivable that the meaning indicated by the utterance text made by Company B above is parsed as “We will also buy a containership” or “We will also go by containership”, unless the context before and after is considered. However, if it is presumed that the context “Company A proposes to Company B a fare increase for containerships (not tramp steamer)” was established before the utterance text made by Company B above, for example, the content of the utterance text made by Company B above is parsed as an act of agreement by Company B. That is, the above-described utterance text made by Company B can be parsed as meaning that Company B has also agreed to the increase in the fare for containerships. In this manner, if dialog text includes an ambiguous utterance text passage that may be parsed differently depending on the context (that is, depending on a relationship with another utterance text passage), it is difficult for a conventional semantic parser that cannot perform semantic analysis in consideration of a dependent relationship between utterance text passages to accurately analyze the meaning of the entire dialog text.

Thus, in order to accurately analyze the entire dialog text using a computer, a pair of utterance text passages having a dependent relationship need be specified from the dialog text as appropriate. This makes it possible to perform semantic analysis in consideration of a dependent relationship between utterance text passages, and to convert each utterance text passage into an appropriate formal language.

An example object of the invention is to provide an information processing apparatus, an information processing method, and a computer-readable recording medium that make it possible to specify utterance text passages having a dependent relationship.

### Means for Solving the Problems

In order to achieve the above-described object, an information processing apparatus according to an example aspect of the invention includes:

a speech act formula generation unit configured to generate a plurality of speech act formulas by respectively converting, using a preset parameter, a plurality of utterance text passages that form dialogue text into formal languages including predicates that indicate illocutionary acts; and

an adjacency pair extraction unit configured to extract, as a pair of speech act formulas indicating an adjacency pair, based on pair information that indicates a plurality of predicate pairs that are each constituted by predicates that indicate a pair of illocutionary acts that are associated with each other, a speech act formula generated by the speech act formula generation unit from an arbitrary utterance text passage in the dialogue text, and a speech act formula including a predicate that forms the predicate pair with a predicate included in the arbitrary speech act formula which is one of a plurality of speech act formulas generated by the speech act formula generation unit from a plurality of utterance text passages other than the arbitrary utterance text passage.

Also, in order to achieve the above-described object, an information processing method according to an example aspect of the invention includes:

(a) a step of generating a plurality of speech act formulas by respectively converting, using a preset parameter, a plurality of utterance text passages that form dialog text into formal languages including predicates that indicate illocutionary acts; and

(b) a step of extracting, as a pair of speech act formulas indicating an adjacency pair, based on pair information that indicates a plurality of predicates pairs that are each constituted by predicates that indicate a pair of illocutionary acts that are associated with each other, a speech act formula generated in the step (a) from an arbitrary utterance text passage in the dialogue text, and a speech act formula including a predicate that forms the predicate pair with a predicate included in the arbitrary speech act formula which is one of a plurality of speech act formulas generated in the step (a) from a plurality of utterance text passages other than the arbitrary utterance text passage.

Furthermore, in order to achieve the above-described object, a computer-readable recording medium according to an example aspect of the invention includes a program recorded thereon, the program including instructions that cause the computer to carry out:

(a) a step of generating a plurality of speech act formulas by respectively converting, using a preset parameter, a plurality of utterance text passages that form dialog text into formal languages including predicates that indicate illocutionary acts; and

(b) a step of extracting, as a pair of speech act formulas indicating an adjacency pair, based on pair information that indicates a plurality of predicates pairs that are each constituted by predicates that indicate a pair of illocutionary acts that are associated with each other, a speech act formula generated in the step (a) from an arbitrary utterance text passage in the dialogue text, and a speech act formula including a predicate that forms the predicate pair with a predicate included in the arbitrary speech act formula which is one of a plurality of speech act formulas generated in the step (a) from a plurality of utterance text passages other than the arbitrary utterance text passage.

### Advantageous Effects of the Invention

As described above, according to the invention, utterance text passages having a dependent relationship can be specified.

### BRIEF DESCRIPTION OF THE DRAWINGS

FIG. 1 is a block diagram showing an information processing apparatus in an example embodiment.

FIG. 2 is a block diagram showing a specific configuration of an information processing apparatus in an example embodiment of the invention.

FIG. 3 is a diagram showing an example of pair information stored in a pair information storage unit.

FIG. 4 is a diagram showing examples of utterance text passages input to a speech act formula generation unit and speech act formulas generated by the speech act formula generation unit.

FIG. 5 is a diagram showing examples of pairs of speech act formulas.

FIG. 6 is a diagram showing an example of dialog information.

FIG. 7 is a flowchart showing operations of the information processing apparatus in an example embodiment of the invention.

FIG. 8 is a block diagram showing an example of a computer that realizes the information processing apparatus in an example embodiment of the invention.

### EXAMPLE EMBODIMENT

### Example Embodiment

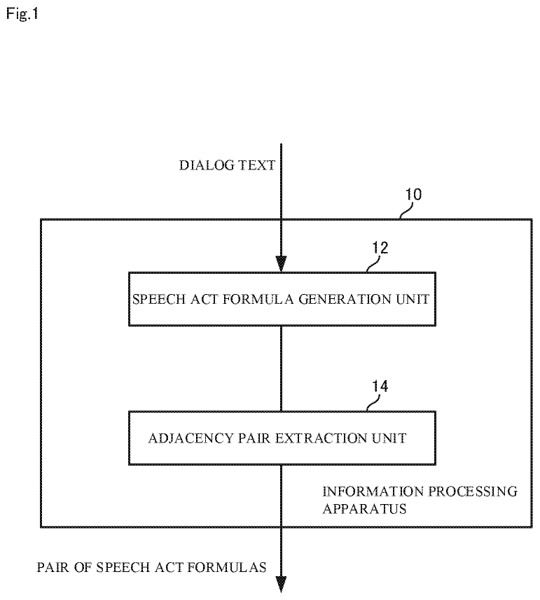

Hereinafter, an information processing apparatus, an information processing method, and a program according to example embodiments of the invention will be described with reference to FIGS. 1 to 8.

[Apparatus Configuration]

FIG. 1 is a block diagram showing an information processing apparatus 10 according to this example embodiment. As shown in FIG. 1, the information processing apparatus 10 of this example embodiment includes a speech act formula generation unit 12 and an adjacency pair extraction unit 14.

Dialog text described in natural language is input to the speech act formula generation unit 12. In this example embodiment, dialog text is formed of a plurality of utterance text passages. Note that text that indicates a series of conversations formed of utterances made by a plurality of speakers is referred to as “dialog text”. Also, in dialog text, text that indicates one utterance is referred to as an “utterance text passage”.

The speech act formula generation unit 12 functions as speech act formula generation means. Specifically, the speech act formula generation unit 12 respectively converts, using a preset parameter, a plurality of utterance text passages into formal languages including predicates that indicate illocutionary acts. Accordingly, speech act formulas described in a formal language are generated from the utterance text passages. In this example embodiment, the speech act formula generation unit 12 converts each utterance text passage into one or more speech act formulas. Note that it is possible to use, as the speech act formula generation unit 12, a known semantic parser configured to output a formula in a formal language based on parameters when text described in natural language is input. Specifically, a technique disclosed in Non-Patent Document 1 can be utilized for the speech act formula generation unit 12, for example.

The adjacency pair extraction unit 14 functions as adjacency pair extraction means. Specifically, the adjacency pair extraction unit 14 extracts a pair of speech act formulas indicating an adjacency pair, from a plurality of speech act formulas generated by the speech act formula generation unit 12. Note that an “adjacency pair” in this example embodiment refers to a combination of a speech act made by a speaker (referred to as a “first component speech act”, hereinafter) and a speech act made by another speaker (referred to as a “second component speech act”, hereinafter) that is linked to the speech act. Dialog text may include a plurality of second component speech acts with respect to one first component speech act.

Also, in this example embodiment, the adjacency pair extraction unit 14 extracts a pair of speech act formulas indicating an adjacency pair, using preset pair information. Although details will be described later, this pair information is information that indicates a plurality of predicate pairs. In this example embodiment, a predicate pair refers to a pair of predicates that indicate illocutionary acts that are associated with each other. Also, in this example embodiment, an “illocutionary act” means that the intention of a speaker is made using a speech act, the intention being included in the speech act. Specifically, an “illocutionary act” means that the intention of a speaker is made using a speech act, such as a question, proposal, answer, agreement, objection, volition, advice, order, or request. Thus, a “predicate pair” in this example embodiment refers to a pair of a predicate that indicates one illocutionary act (referred to as a “first component predicate”, hereinafter) and a predicate that indicates an illocutionary act made by another speaker who makes a response to the one illocutionary act (referred to as a “second component predicate”, hereinafter). In this example embodiment, a plurality of predicate pairs, such as a predicate pair “question (first component)” and “answer (second component)”, a predicate pair “proposal (first component)” and “agreement (second component)”, and a predicate pair “proposal (first component)” and “objection (second component)”, are preset as pair information, for example.

Although details will be described later, in this example embodiment, the adjacency pair extraction unit 14 extracts a speech act formula that includes a first component predicate, from one or more speech act formulas (referred to as a “speech act formula of a first component candidate”, hereinafter) that are generated from one utterance text passage by the speech act formula generation unit 12. A speech act formula extracted from a speech act formula of the first component candidate is referred to as a “first component speech act formula”. Also, the utterance text passage from which the speech act formula of the first component candidate is obtained is referred to as a “first component utterance text passage”.

Then, the adjacency pair extraction unit 14 extracts, based on the above-described pair information, a speech act formula that includes a second component predicate corresponding to the first component predicate of the first component speech act formula, from a plurality of speech act formulas other than the speech act formula of the first component candidate (referred to as “speech act formulas of a second component candidate”). A speech act formula extracted from the speech act formulas of the second component candidate is referred to as a “second component speech act formula” hereinafter. Also, the utterance text passage from which the speech act formula of the second component candidate is obtained is referred to as a “second component utterance text passage”.

In this example embodiment, the adjacency pair extraction unit 14 outputs the first component speech act formula and the second component speech act formula that are extracted in the above-described manner, as a pair of speech act formulas indicating an adjacency pair.

As described above, in this example embodiment, a pair of speech act formulas indicating an adjacency pair can be extracted based on the preset pair information, from a plurality of speech act formulas generated from a plurality of utterance text passages. More specifically, the second component speech act formula can be extracted in consideration of the first component predicate of the first component speech act formula extracted arbitrarily. Thus, the second component speech act formula can be extracted in consideration of the content of the first component speech act in this example embodiment. In other words, when semantic analysis is performed on one utterance text passage (the second component utterance text passage), it is possible to consider a dependent relationship with another utterance text passage (the first component utterance text passage). This makes it possible to convert each utterance text passage into an appropriate formal language.

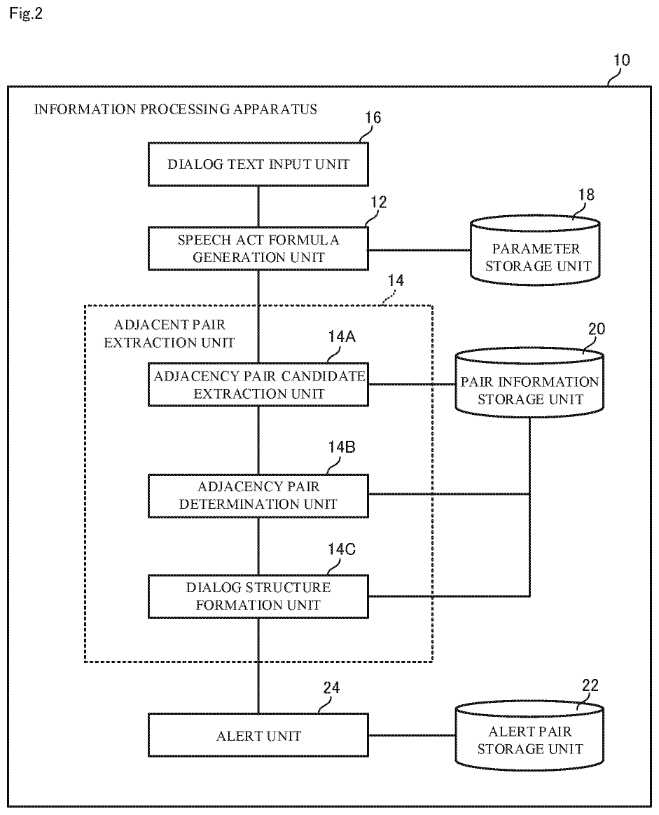

Then, the configuration of an information processing apparatus of this example embodiment of the invention will be more specifically described with reference to FIG. 2. FIG. 2 is a block diagram showing a specific configuration of the information processing apparatus according to an example embodiment of the invention.

Referring to FIG. 2, the information processing apparatus 10 according to this example embodiment further includes a dialog text input unit 16, a parameter storage unit 18, a pair information storage unit 20, an alert pair storage unit 22, and an alert unit 24, in addition to the above-described speech act formula generation unit 12 and adjacency pair extraction unit 14. Also, the adjacency pair extraction unit 14 includes an adjacency pair candidate extraction unit 14a, an adjacency pair determination unit 14b, and a dialog structure formation unit 14c, in this example embodiment.

In this example embodiment, parameters that are to be utilized by the speech act formula generation unit 12 when text described in natural language is to be converted into a formal language are stored in the parameter storage unit 18. Note that, as described above, a technique of a known semantic parser can be utilized as a technique for converting text described in natural language into a formal language, and thus the speech act formula generation unit 12 and the parameter storage unit 18 will not be described in detail.

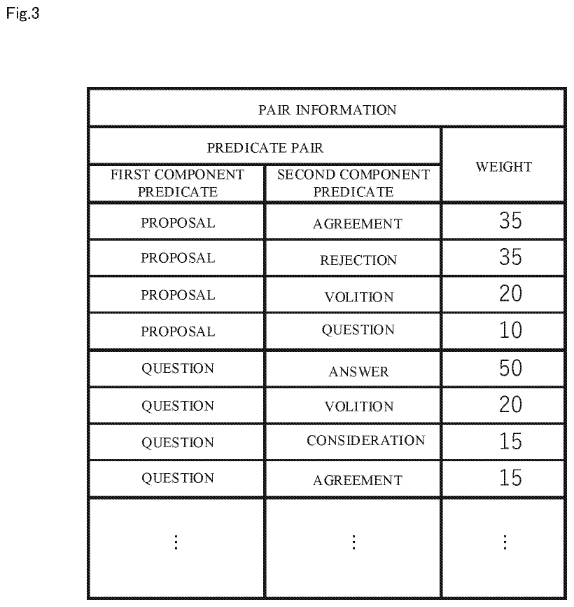

Pair information is stored in the pair information storage unit 20. FIG. 3 is a diagram showing an example of pair information stored in the pair information storage unit 20. As shown in FIG. 3, in this example embodiment, a plurality of predicate pairs and weights added to the predicate pairs are stored in the pair information storage unit 20 as pair information. Note that, although four predicate pairs where “proposal” is the first component predicate and four predicate pairs where “question” is the first component predicate are shown in the example in FIG. 3, combinations of predicate pairs, the number of predicate pairs, and weights of predicate pairs are not limited to the examples shown in FIG. 3, and can be set as appropriate.

Pairs of alert predicates are stored in the alert pair storage unit 22. In this example embodiment, a “pair of alert predicates” refers to a predicate pair set in advance by an administrator of the information processing apparatus 10, for example. A predicate pair “proposal-agreement” is stored in the alert pair storage unit 22 as the pair of alert predicates in this example embodiment, for example. The pair of alert predicates will be described later.

Referring to FIG. 2, the dialog text input unit 16 inputs dialog text to the speech act formula generation unit 12. Note that, in this example embodiment, the dialog text input unit 16 extracts dialog text (utterance text made by a plurality of speakers) from an e-mail or a dialog log, for example, and inputs the extracted dialog text to the speech act formula generation unit 12.

The speech act formula generation unit 12 converts each utterance text passage received from the dialog text input unit 16 into a speech act formula described in a formal language, using parameters stored in the parameter storage unit 18.

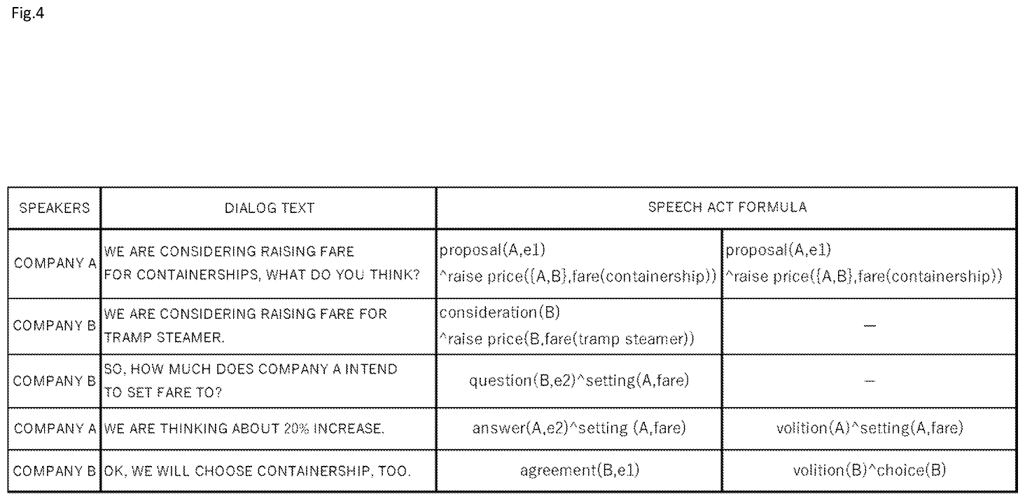

Examples of utterance text passages that are input to the speech act formula generation unit 12 and speech act formulas generated by the speech act formula generation unit 12 are shown in FIG. 4. As shown in FIG. 4, in this example embodiment, the speech act formula generation unit 12 converts each utterance text passage into one or more speech act formulas. Note that the speech act formulas shown in FIG. 4 are examples, and the speech act formula generation unit 12 may convert each utterance text passage into three or more speech act formulas. Also, the formal language shown in FIG. 4 is an example, and the speech act formula generation unit 12 may generate a speech act formula described in another formal language.

Referring to FIG. 2, the speech act formula generation unit 12 inputs the generated speech act formulas to the adjacency pair candidate extraction unit 14a of the adjacency pair extraction unit 14. The adjacency pair candidate extraction unit 14a extracts candidates for a pair of speech act formulas corresponding to the adjacency pair, from a plurality of speech act formulas received from the speech act formula generation unit 12, based on pair information stored in the pair information storage unit 20.

Specifically, the adjacency pair candidate extraction unit 14a first extracts, from a plurality of speech act formulas, a speech act formula that includes a first component predicate, based on pair information (see FIG. 3). If a plurality of speech act formulas shown in FIG. 4 are input to the adjacency pair candidate extraction unit 14a, the adjacency pair candidate extraction unit 14a first extracts the Company A speech act formula “proposal(A,e1)\hat{ }raise price({A,B},fare(containership))” that includes the first component predicate “proposal”, for example.

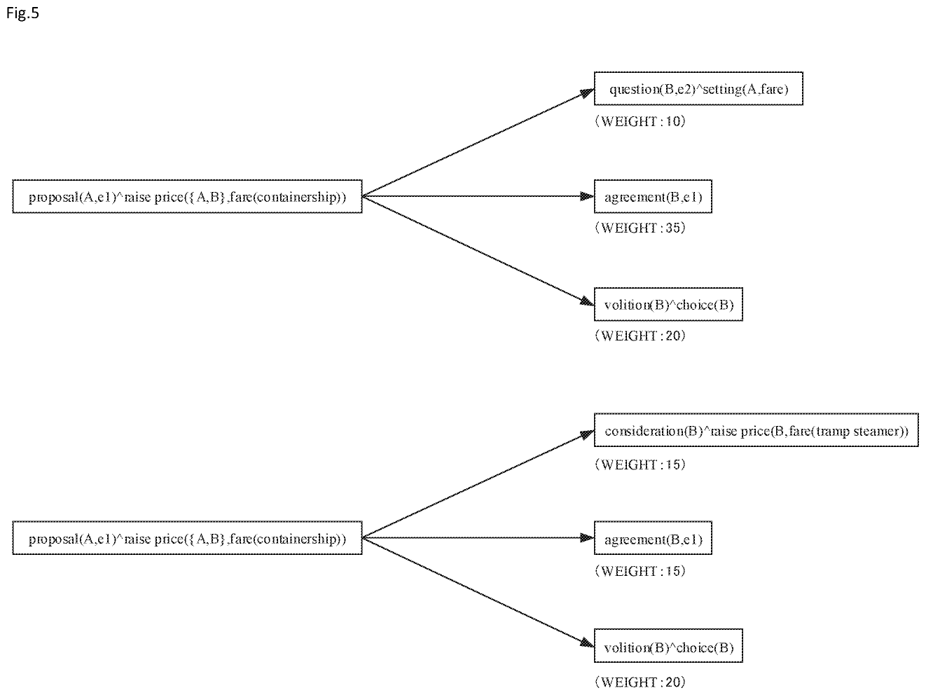

Then, the adjacency pair candidate extraction unit 14a extracts, based on the pair information (see FIG. 3), the Company B speech act formula “question(B,e2)\hat{ }setting(A,fare)” that includes the second component predicate “question” that forms a predicate pair with the first component predicate “proposal” of the Company A speech act formula, as a pair candidate for the speech act formula “proposal(A,e1)\hat{ }raise price({A,B},fare(containership)”. Also, referring to FIGS. 4 and 5, the adjacency pair candidate extraction unit 14a extracts the Company B speech act formula “agreement(B,e1)” that includes the second component predicate “agreement” and the Company B speech act formula “volition(B)\hat{ }choice(B)” that includes the second component predicate “volition” as pair candidates for the speech act formula “proposal(A,e1)\hat{ }raise price({A,B},fare(containership)”.

Although a detailed description is omitted, as shown in FIG. 5, similarly to the Company A speech act formula “question(A,e1)\hat{ }raise price({A,B},fare(containership))”, the speech act formulas “consideration(B)\hat{ }raise price(B,fare(tramp steamer))”, and “agreement(B,e1)” and “volition(B)\hat{ }choice(B)” are extracted as speech act formulas of pair candidates, based on pair information. Also, although not shown, similarly to the other speech act formula that includes the first component predicate, speech act formulas that serve as pair candidates for each speech act formula are extracted. In this manner, the adjacency pair candidate extraction unit 14a extracts candidates for pairs of speech act formulas that correspond to an adjacency pair, and inputs a plurality of the extracted pair candidates to the adjacency pair determination unit 14b.

Referring to FIG. 2, the adjacency pair determination unit 14b determines a pair of speech act formulas that are appropriate as an adjacency pair (a plausible pair), from the plurality of pair candidates received from the adjacency pair candidate extraction unit 14a, based on the pair information stored in the pair information storage unit 20.

Assume that, with regard to the utterance text “We are considering raising the fare for containerships, what do you think?” in FIG. 4, for example, as shown in FIG. 5, six combinations of speech act formulas are input to the adjacency pair determination unit 14b as candidates for pairs of speech act formulas that correspond to an adjacency pair. In this case, the adjacency pair determination unit 14b determines a pair of speech act formulas that correspond to a predicate pair “proposal-agreement” to which the largest weight has been added, as a pair of speech act formulas that are most likely to be an adjacency pair. That is, in the example shown in FIG. 5, a combination of “proposal(A,e1)\hat{ }raise price({A,B},fare(containership))” and “agreement(B,e1)” is determined as a pair of appropriate speech act formulas.

In this example embodiment, the adjacency pair determination unit 14b determines pairs of appropriate speech act formulas for each utterance text passage. That is, the adjacency pair determination unit 14b searches for pairs of appropriate speech act formulas that indicate adjacency pairs, for each utterance text passage. Although a detailed description is omitted, with regard to the utterance text “So, how much does Company A intend to set the fare to?” in FIG. 4, the adjacency pair determination unit 14b determines the combination of “question(B,e2)\hat{ }setting(A,fare)” and “answer(A,e2)\hat{ }setting(A,fare)” as a pair of appropriate speech act formulas, for example.

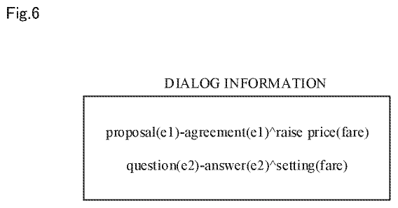

The adjacency pair determination unit 14b inputs, to the dialog structure formation unit 14c, the combination of the speech act formulas that have been determined as the pair of appropriate speech act formulas. The dialog structure formation unit 14c functions as dialog structure formation means. Specifically, the dialog structure formation unit 14c generates dialog information that indicates a dialog structure for each pair of input speech act formulas. In this example embodiment, the dialog structure formation unit 14c generates, as dialog information, a dialog formula described in a formal language. If a pair of “proposal(A,e1)\hat{ }raise price({A,B},fare(containership))” and “agreement(B,e1)”, and a pair of “question(B,e2)\hat{ }setting(A,fare) and “answer(A,e2)\hat{ }setting(A,fare)” are input, for example, the dialog structure formation unit 14c generates two pieces of dialog information (dialog formulas) such as that shown in FIG. 6. In this example embodiment, the dialog structure formation unit 14c generates dialog information using a predicate pair (a predicate pair “proposal-agreement” and a predicate pair “question-answer” in this example embodiment) that are included in each pair of speech act formulas received from the adjacency pair determination unit 14b. In this example embodiment, the dialog structure formation unit 14c generates dialog information for each pair of speech act formulas based on pair information stored in the pair information storage unit 20, for example. The dialog structure formation unit 14c inputs the generated dialog information to the alert unit 24. Also, in this example embodiment, the dialog structure formation unit 14c further outputs the generated dialog information to a display apparatus (not shown) or the like so as to display the dialog information, for example.

The alert unit 24 functions as alert means. Specifically, the alert unit 24 generates an alert signal based on pairs of alert predicates stored in the alert pair storage unit 22. Specifically, if dialog information received from the dialog structure formation unit 14c includes a pair of alert predicates, the alert unit 24 generates an alert signal. Assume that a pair of alert predicates “proposal-agreement” is stored in the alert pair storage unit 22, and two pieces of dialog information shown in FIG. 6 are input to the alert unit 24, for example. In this case, the alert unit 24 determines that one piece of dialog information “proposal(e1)-agreement(e1)\hat{ }raise price(fare)” includes the pair of alert predicates “proposal-agreement”, and generates an alert signal. In this example embodiment, the alert unit 24 outputs the alert signal to a display apparatus (not shown) or the like to cause the display apparatus to display the alert information, for example. Note that the above-described pair of alert predicates is an example, and other pairs of alert predicates may be stored in the alert pair storage unit 22. Also, the number of pairs of alert predicates stored in the alert pair storage unit 22 is not limited to one, and a plurality of pairs of alert predicates may be stored in the alert pair storage unit 22.

As described above, when semantic analysis is performed on one utterance text passage, the information processing apparatus 10 according to this example embodiment can consider a dependent relationship with another utterance text passage. As described above, this makes it possible to convert the utterance text passage “choose” into the predicate “agreement”, instead of the predicate “choice”, for example. That is, it is possible to convert each utterance text passage into an appropriate formal language in consideration of a dependent relationship between utterance text passages.

Also, in this example embodiment, dialog information is generated by the adjacency pair extraction unit 14, and thus, as a result of checking the dialog information, a user can easily understand what kind of conversations were had by a plurality of speakers. Also, in this example embodiment, the alert unit 24 generates an alert signal based on pairs of alert predicates stored in the alert pair storage unit 22 in advance. Thus, setting pairs of alert predicates as appropriate makes it possible to detect that conversations that violate a specific rule (e.g., conversations relating to compliance violations) were had by a plurality of speakers, for example.

[Apparatus Operations]

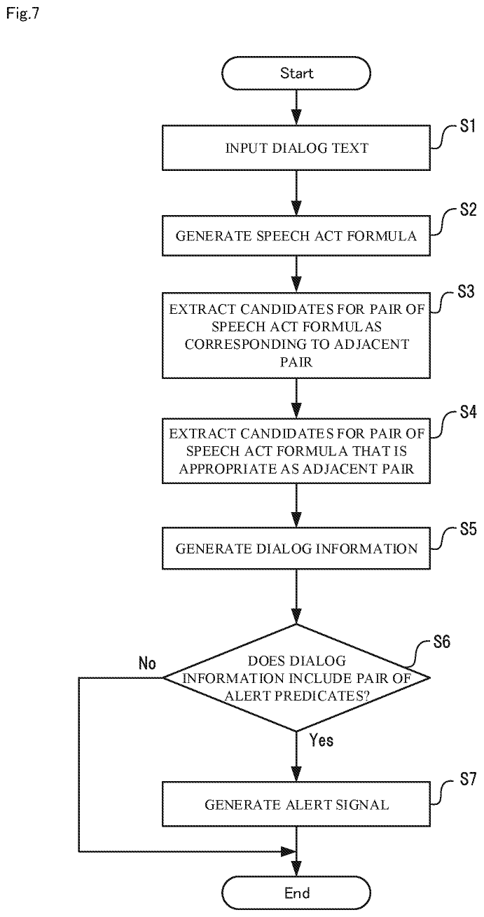

Next, operations of the information processing apparatus in an example embodiment of the invention will be described with reference to FIG. 7. FIG. 7 is a flowchart showing operations of the information processing apparatus in an example embodiment of the invention. The following description also references FIGS. 1 to 6 as appropriate. Also, in this example embodiment, an information processing method is implemented by causing the information processing apparatus 10 to operate. Accordingly, the following description of operations of the information processing apparatus 10 will substitute for a description of an information processing method according to this example embodiment.

Referring to FIG. 7, as described above, in the information processing apparatus 10, first, the dialog text input unit 16 inputs dialog text (a plurality of utterance text passages) to the speech act formula generation unit 12 (step S1). Then, the speech act formula generation unit 12 converts the utterance text passages received from the dialog text input unit 16 into speech act formulas described in a formal language, using parameters stored in the parameter storage unit 18 (step S2).

Then, the adjacency pair candidate extraction unit 14a extracts candidates for a pair of speech act formulas corresponding to an adjacency pair, from a plurality of speech act formulas generated by the speech act formula generation unit 12, based on pair information stored in the pair information storage unit 20 (step S3).

Then, the adjacency pair determination unit 14b extracts a pair of speech act formulas that are most likely to be an adjacency pair, from the plurality of pair candidates received from the adjacency pair candidate extraction unit 14a, based on the pair information stored in the pair information storage unit 20 (step S4). In this example embodiment, a pair of speech act formulas that is most likely to be an adjacency pair is extracted for each utterance text passage as in step S4.

Then, the dialog structure formation unit 14c generates dialog information that indicates a dialog structure based on the pair of speech act formulas for each utterance text passage received from the adjacency pair determination unit 14b (step S5).

The alert unit 24 then determines whether or not the dialog information generated by the dialog structure formation unit 14c includes a pair of alert predicates (step S6). If the dialog information includes a pair of alert predicates, the alert unit 24 generates an alert signal to cause the display apparatus or the like to display alert information (step S7).

On the other hand, in step S6, if the dialog information does not include a pair of alert predicates, the alert unit 24 does not generate an alert signal and processing ends.

Note that, although an example in which the number of speakers is two has been described in the above-described example embodiment, the number of speakers may be three or more.

[Program]

A program according to an example embodiment of the invention may be a program for causing a computer to execute steps S1 to S7 shown in FIG. 7. The information processing apparatus and the information processing method of this example embodiment can be realized by installing the program in the computer and executing it. In this case, a processor of the computer serving as the information processing apparatus functions as, and performs processing as, the speech act formula generation unit 12, the adjacency pair extraction unit 14, the dialog text input unit 16, and the alert unit 24. Also, in this example embodiment, the parameter storage unit 18, the pair information storage unit 20, and the alert pair storage unit 22 are realized by storing data files constituting such storage units in a storage apparatus such as a hard disk included in the computer, or by loading a recording medium having such data files stored thereon in a reading apparatus connected to the computer.

Also, the program of this example embodiment may be executed by a computer system constructed by multiple computers. In this case, the computers may each function as any one or more of the speech act formula generation unit 12, the adjacency pair candidate extraction unit 14a, the adjacency pair determination unit 14b, the dialog structure formation unit 14c, the dialog text input unit 16, and the alert unit 24, for example. Also, the parameter storage unit 18, the pair information storage unit 20, and the alert pair storage unit 22 may be constructed on a computer other than the computer that executes the program according to this example embodiment.

[Physical Configuration]

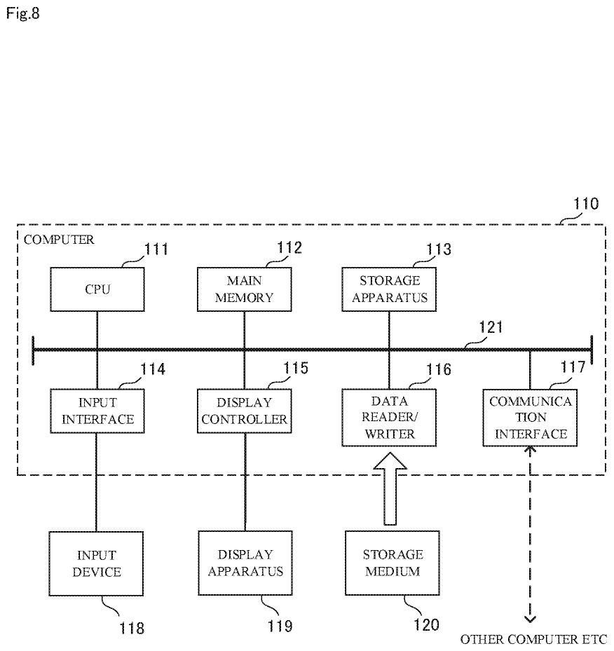

A computer that realizes the information processing apparatus by executing the program of this example embodiment will be described below with reference to the drawings. FIG. 8 is a block diagram showing an example of the computer that realizes the information processing apparatus in an example embodiment of the invention.

As shown in FIG. 8, a computer 110 includes a CPU (Central Processing Unit) Ill, a main memory 112, a storage apparatus 113, an input interface 114, a display controller 115, a data reader/writer 116, and a communication interface 117. These members are connected via a bus 121 to enable the exchange of data therebetween. Note that the computer 110 may include a GPU (Graphics Processing Unit) or an FPGA (Field-Programmable Gate Array) in addition to the CPU 111 or instead of the CPU 111.

The CPU 111 carries out various types of arithmetic calculation by loading the program (code) of this example embodiment, which is stored in the storage apparatus 113, to the main memory 112 and executing portions of the program in a predetermined sequence. The main memory 112 is typically a volatile storage apparatus such as a DRAM (Dynamic Random Access Memory). Also, the program of this example embodiment is provided in a state of being stored on a computer readable recording medium 120. Note that the program of this example embodiment may be distributed over the Internet, which can be accessed via the communication interface 117.

Besides a hard disk drive, other examples of the storage apparatus 113 include a semiconductor storage apparatus such as a flash memory. The input interface 114 mediates the transfer of data between the CPU 111 and input devices 118 such as a keyboard and a mouse. The display controller 115 is connected to a display apparatus 119 and controls display performed by the display apparatus 119.

The data reader/writer 116 mediates the transfer of data between the CPU 111 and the recording medium 120, reads out the program from the recording medium 120, and writes processing results obtained by the computer 110 to the recording medium 120. The communication interface 117 mediates the transfer of data between the CPU 111 and other computers.

Examples of the recording medium 120 include a general-purpose semiconductor storage device such as a CF (Compact Flash (registered trademark)) or an SD (Secure Digital) card, a magnetic storage medium such as a flexible disk, and an optical storage medium such as a CD-ROM (Compact Disk Read Only Memory).

Note that the information processing apparatus according to an example embodiment of the invention can also be realized with use of hardware that corresponds to the above-described units, instead of a computer having the program installed therein. Furthermore, a configuration is possible in which one portion of the information processing apparatus is realized by a program, and the remaining portion is realized by hardware.

The example embodiments described above can be partially or entirely realized by Supplementary Notes 1 to 12 listed below, but the invention is not limited to the following descriptions.

(Supplementary Note 1)

An information processing apparatus including:

a speech act formula generation unit configured to generate a plurality of speech act formulas by respectively converting, using a preset parameter, a plurality of utterance text passages that form dialogue text into formal languages including predicates that indicate illocutionary acts; and

an adjacency pair extraction unit configured to extract, as a pair of speech act formulas indicating an adjacency pair, based on pair information that indicates a plurality of predicate pairs that are each constituted by predicates that indicate a pair of illocutionary acts that are associated with each other, a speech act formula generated by the speech act formula generation unit from an arbitrary utterance text passage in the dialogue text, and a speech act formula including a predicate that forms the predicate pair with a predicate included in the arbitrary speech act formula which is one of a plurality of speech act formulas generated by the speech act formula generation unit from a plurality of utterance text passages other than the arbitrary utterance text passage.

(Supplementary Note 2)

The information processing apparatus according to Supplementary Note 1,

wherein weights are respectively added to the plurality of predicate pairs in the pair information in advance, and

in a case where a plurality of pairs of speech act formulas include one or more speech act formulas generated from the arbitrary utterance text passage and one or more speech act formulas generated from one utterance text passage other than the arbitrary utterance text passage, the adjacency pair extraction unit extracts a pair of speech act formulas including a predicate pair to which the largest weight has been added in the pair information, as a pair of speech act formulas indicating the adjacency pair.

(Supplementary Note 3)

The information processing apparatus according to Supplementary Note 1 or 2,

wherein the adjacency pair extraction unit searches for the pair of speech act formulas indicating the adjacency pair, for each of the utterance text passages.

(Supplementary Note 4)

The information processing apparatus according to any of Supplementary Notes 1 to 3, further including:

a dialog structure formation unit configured to generate dialog information described in a formal language, for each pair of speech act formulas indicating the adjacency pair, using the predicate pair included in the pair of speech act formulas; and

an alert unit configured to generate an alert signal in a case where the dialog information generated by the dialog structure formation unit includes a pair of alert predicates set in advance.

(Supplementary Note 5)

An information processing method including:

(a) a step of generating a plurality of speech act formulas by respectively converting, using a preset parameter, a plurality of utterance text passages that form dialogue text into formal languages including predicates that indicate illocutionary acts; and

(b) a step of extracting, as a pair of speech act formulas indicating an adjacency pair, based on pair information that indicates a plurality of predicates pairs that are each constituted by predicates that indicate a pair of illocutionary acts that are associated with each other, a speech act formula generated in the step (a) from an arbitrary utterance text passage in the dialogue text, and a speech act formula including a predicate that forms the predicate pair with a predicate included in the arbitrary speech act formula which is one of a plurality of speech act formulas generated in the step (a) from a plurality of utterance text passages other than the arbitrary utterance text passage.

(Supplementary Note 6)

The information processing method according to Supplementary Note 5,

wherein weights are respectively added to the plurality of predicate pairs in the pair information in advance, and

in a case where a plurality of pairs of speech act formulas include one or more speech act formulas generated from the arbitrary utterance text passage and one or more speech act formulas generated from one utterance text passage other than the arbitrary utterance text passage, in the (b) step, a pair of speech act formulas including a predicate pair to which the largest weight has been added in the pair information is extracted as a pair of speech act formulas indicating the adjacency pair.

(Supplementary Note 7)

The information processing method according to Supplementary Note 5 or 6,

wherein, in the (b) step, the pair of speech act formulas indicating the adjacency pair is searched for, for each of the utterance text passages.

(Supplementary Note 8)

The information processing method according to any of Supplementary Notes 5 to 7, further including:
(c) a step of generating dialog information described in a formal language, for each pair of speech act formulas extracted in the (b) step, using the predicate pair included in the pair of speech act formulas; and
(d) a step of generating an alert signal in a case where the dialog information generated in the (c) step includes a pair of alert predicates set in advance.

(Supplementary Note 9)

A non-transitory computer readable recording medium that includes a program recorded thereon, the program including instructions that cause a computer to carry out:

(a) a step of generating a plurality of speech act formulas by respectively converting, using a preset parameter, a plurality of utterance text passages that form dialogue text into formal languages including predicates that indicate illocutionary acts; and

(b) a step of extracting, as a pair of speech act formulas indicating an adjacency pair, based on pair information that indicates a plurality of predicates pairs that are each constituted by predicates that indicate a pair of illocutionary acts that are associated with each other, a speech act formula generated in the step (a) from an arbitrary utterance text passage in the dialogue text, and a speech act formula including a predicate that forms the predicate pair with a predicate included in the arbitrary speech act formula which is one of a plurality of speech act formulas generated in the step (a) from a plurality of utterance text passages other than the arbitrary utterance text passage.

(Supplementary Note 10)

The non-transitory computer readable recording medium according to Supplementary Note 9,

wherein weights are respectively added to the plurality of predicate pairs in the pair information in advance, and

in a case where a plurality of pairs of speech act formulas include one or more speech act formulas generated from the arbitrary utterance text passage and one or more speech act formulas generated from one utterance text passage other than the arbitrary utterance text passage, in the (b) step, a pair of speech act formulas including a predicate pair to which the largest weight has been added in the pair information is extracted as a pair of speech act formulas indicating the adjacency pair.

(Supplementary Note 11)

The non-transitory computer readable recording medium according to Supplementary Note 9 or 10,

wherein, in the (b) step, the pair of speech act formulas indicating the adjacency pair is searched for, for each of the utterance text passages.

(Supplementary Note 12)

The non-transitory computer readable recording medium according to any of Supplementary Notes 9 to 11, the program causing the computer to further carry out:

(c) a step of generating dialog information described in a formal language, for each pair of speech act formulas extracted in the (b) step, using the predicate pair included in the pair of speech act formulas; and

(d) a step of generating an alert signal in a case where the dialog information generated in the (c) step includes a pair of alert predicates set in advance.

Although the invention has been described by way of example embodiments above, the invention is not limited to the above example embodiments. Configurations and details of the invention can be changed in various ways that would be understandable to a person skilled in the art within the scope of the invention.

This application is based upon and claims the benefit of priority from Japanese application No. 2017-098383, filed on May 17, 2017, the disclosure of which is incorporated herein in its entirety by reference.

### INDUSTRIAL APPLICABILITY

As described above, according to the invention, the meaning of each utterance text passage can be analyzed as appropriate by specifying utterance text passages having a dependent relationship.

### REFERENCE NUMERALS

10 Information processing apparatus
12 Speech act formula generation unit
14 adjacency pair extraction unit
16 Dialog text input unit
18 Parameter storage unit
20 Pair information storage unit
22 Alert pair storage unit
24 Alert unit
110 Computer
111 CPU
112 Main memory
113 Storage apparatus
114 Input interface
115 Display controller
116 Data reader/writer
117 Communication interface
118 Input device
119 Display apparatus
120 Recording medium
121 Bus

1. An information processing apparatus comprising:
A speech act formula generation circuit configured to generate a plurality of speech act formulas by respectively converting, using a preset parameter, a plurality of utterance text passages that form dialogue text into formal languages including predicates that indicate illocutionary acts; and
an adjacency pair extraction circuit configured to extract, as a pair of speech act formulas indicating an adjacency pair, based on pair information that indicates a plurality of predicate pairs that are each constituted by predicates that indicate a pair of illocutionary acts that are associated with each other, a speech act formula generated by the speech act formula generation circuit from an arbitrary utterance text passage in the dialogue text, and a speech act formula including a predicate that forms the predicate pair with a predicate included in the arbitrary speech act formula which is one of a plurality of speech act formulas generated by the speech act formula generation circuit from a plurality of utterance text passages other than the arbitrary utterance text passage.

2. The information processing apparatus according to claim 1,
wherein weights are respectively added to the plurality of predicate pairs in the pair information in advance, and
in a case where a plurality of pairs of speech act formulas include one or more speech act formulas generated from the arbitrary utterance text passage and one or more speech act formulas generated from one utterance text passage other than the arbitrary utterance text passage, the adjacency pair extraction circuit extracts a pair of speech act formulas including a predicate pair to which the largest weight has been added in the pair information, as a pair of speech act formulas indicating the adjacency pair.

3. The information processing apparatus according to claim 1,
wherein the adjacency pair extraction circuit searches for the pair of speech act formulas indicating the adjacency pair, for each of the utterance text passages.

4. The information processing apparatus according to claim 1, further comprising:
A dialog structure formation circuit configured to generate dialog information described in a formal language, for each pair of speech act formulas indicating the adjacency pair, using the predicates pair included in the pair of speech act formulas; and
An alert circuit configured to generate an alert signal in a case where the dialog information generated by the dialog structure formation circuit includes a pair of alert predicates set in advance.

5. An information processing method comprising:
generating a plurality of speech act formulas by respectively converting, using a preset parameter, a plurality of utterance text passages that form dialogue text into formal languages including predicates that indicate illocutionary acts; and
extracting, as a pair of speech act formulas indicating an adjacency pair, based on pair information that indicates a plurality of predicates pairs that are each constituted by predicates that indicate a pair of illocutionary acts that are associated with each other, a speech act formula generated from an arbitrary utterance text passage in the dialogue text, and a speech act formula including a predicate that forms the predicate pair with a predicate included in the arbitrary speech act formula which is one of a plurality of speech act formulas generated from a plurality of utterance text passages other than the arbitrary utterance text passage.

6. The information processing method according to claim 5,
wherein weights are respectively added to the plurality of predicate pairs in the pair information in advance, and
in a case where a plurality of pairs of speech act formulas include one or more speech act formulas generated from the arbitrary utterance text passage and one or more speech act formulas generated from one utterance text passage other than the arbitrary utterance text passage, when the pair of speech act formulas is extracted, a pair of speech act formulas including a predicate pair to which the largest weight has been added in the pair information is extracted as a pair of speech act formulas indicating the adjacency pair.

7. The information processing method according to claim 5,
wherein, when the pair of speech act formulas is extracted, the pair of speech act formulas indicating the adjacency pair is searched for, for each of the utterance text passages.

8. The information processing method according to claim 5, further comprising:
generating dialog information described in a formal language, for each pair of speech act formulas extracted, using the predicate pairs included in the pair of speech act formulas; and
generating an alert signal in a case where the dialog information generated includes a pair of alert predicates set in advance.

9. A non-transitory computer readable recording medium that includes a program recorded thereon, the program including instructions that cause a computer to carry out:
generating a plurality of speech act formulas by respectively converting, using a preset parameter, a plurality of utterance text passages that form dialogue text into formal languages including predicates that indicate illocutionary acts; and
extracting, as a pair of speech act formulas indicating an adjacency pair, based on pair information that indicates a plurality of predicates pairs that are each constituted by predicates that indicate a pair of illocutionary acts that are associated with each other, a speech act formula generated from an arbitrary utterance text passage in the dialogue text, and a speech act formula including a predicate that forms the predicate pair with a predicate included in the arbitrary speech act formula which is one of a plurality of speech act formulas generated from a plurality of utterance text passages other than the arbitrary utterance text passage.

10. The non-transitory computer readable recording medium according to claim 9,
wherein weights are respectively added to the plurality of predicate pairs in the pair information in advance, and
in a case where a plurality of pairs of speech act formulas include one or more speech act formulas generated from the arbitrary utterance text passage and one or more speech act formulas generated from one utterance text passage other than the arbitrary utterance text passage, when the pair of speech act formulas is extracted, a pair of speech act formulas including a predicate pair to which the largest weight has been added in the pair information is extracted as a pair of speech act formulas indicating the adjacency pair.

11. The non-transitory computer readable recording medium according to claim 9,
wherein, when the pair of speech act formulas is extracted, the pair of speech act formulas indicating the adjacency pair is searched for, for each of the utterance text passages.

12. The non-transitory computer readable recording medium according to claim 9, the program including instructions that cause the computer to further carry out:
generating dialog information described in a formal language, for each pair of speech act formulas extracted, using the predicate pair included in the pair of speech act formulas; and
generating an alert signal in a case where the dialog information generated includes a pair of alert predicates set in advance.
